(19) United States
(12) Patent Application Publication
(10) Pub. No.: US 2005/0223765 A1
(43) Pub. Date: Oct. 13, 2005

(54) Snap-in lock retention system for a safe

(76) Inventors: James E. Masseth JR., Henrietta, NY (US); David A. Nowicky, Fairport, NY (US)

Correspondence Address: Jaeckle Fleischmann & Mugel, LLP, 190 Linden Oaks, Rochester, NY, 14625-2812, US

(21) Appl. No.: 11/149,798

(22) Filed: Jun. 10, 2005

Related U.S. Application Data
(63) Continuation of application No. 10/268,347, filed on Oct. 10, 2002.

(51) Int. Cl. E05B 9/08

(52) U.S. Cl. 70/370

(57) ABSTRACT

This system allows a lock to be snap fit into an escutcheon plate in a secure mount that holds the lock irremovability in place in a proper position so that it cannot rotate or slide axially inward or outward. The lock socket has a pair of alignment flats to receive the lock in a proper orientation and an opposed pair of resilient snap locks. The resilient snap locks are free to move radially in and out. The lock barrel has a cam surface leading up to the diameter that fits in the lock socket. The diameter includes a pair of alignment flats and an opposed pair of snap lock flats. As the lock is inserted, the cam surface spreads open the resilient snap locks. These pass over the retainer lip and snap into the snap lock flats where the snap locks retain the lock barrel against axial movement.

### CROSS-REFERENCE TO RELATED APPLICATIONS

This application is a continuation of U.S. application Ser. No. 10/268,347, which was filed on Oct. 10, 2002.

### TECHNICAL FIELD

Our invention deals with a lock retention system for a safe that allows a lock to be securely mounted by merely snapping the lock into operating position without the necessity of using separate clips, pins, or other retainers to hold the lock in place.

### BACKGROUND OF THE INVENTION

The bodies and doors/lids of our company's fire-resistant storage containers, also referred to as fire-resistant safes, are constructed by joining internal and external shells together so that they form a mold that can be filled with insulation material. (The insulation material itself is generally a concrete mixture that solidifies in the mold formed by the internal and external shells.) Each double-walled shell is molded with a pair of funnels that are used to help fill the shell with the insulation material. Escutcheons are mounted over the funnels immediately after the shells are filled. These escutcheons are made with stakes having shaped ends that are inserted through the funnels and embedded in the insulation material before the insulation material has hardened in place.

Lock cylinders for the safe and mechanisms related thereto are normally affixed underneath and to one of these escutcheons. In order to accomplish this in the most cost effective and efficient manner, it is desirable to make the operation as simple as possible. In most applications, a separate fastener clip or member is used to retain a lock cylinder in a panel or socket. However, some have sought to simplify this operation even more by producing snap-in locks that do not use separate fasteners and retainers. U.S. Pat. No. 5,297,405 issued to Manning et al. in 1994 for a “Door Handle Assembly with Snap-in Key Cylinder” provides one example of such an attempt.

In U.S. Pat. No. 5,297,405 (“Manning”), the inward side of a door handle assembly has semi-rigid fingers that extend inwardly. These fingers are shaped so as to snugly embrace and abut the sides of a key cylinder inserted from the rear. Each finger has a rectangular opening that receives a snap-in stud located on the exterior of the key cylinder when the cylinder is inserted into position. A narrowed opening where the key slot is exposed is too small for the key cylinder to slide forward and through. Further motion in this direction is, therefore, blocked. Once the studs have snapped into the previously described openings, the key cylinder also cannot slide back. Thus, Manning presents one means and apparatus by which a manufacturer has sought to simplify and expedite the process of lock installation; however, there remains a need for other methods and apparatus to accomplish this same purpose.

### SUMMARY OF THE INVENTION

Our invention allows a lock to be snap fit into an escutcheon plate in a secure mount that holds the lock irremovably in place in a proper position so that it cannot rotate or slide axially inward or outward. It eliminates the need for any fastener, since the complete locking effect is supplied by the shape of the lock barrel and the molded shape of the lock socket/escutcheon plate.

The lock socket molded into the escutcheon plate has a pair of alignment flats to receive the lock in a proper orientation and an opposed pair of resilient snap locks. These are free to move radially in and out by virtue of a slot that partially separates the snap locks from the rest of the escutcheon plate.

The lock barrel has cam surfaces leading up to the diameter that fits in the lock socket. This diameter also includes a pair of alignment flats and an opposed pair of snap lock flats. A lock flange on the outside of the lock limits depth of insertion of the lock into its socket. As the lock is inserted, the cam surface radially spreads open the resilient snap locks. These pass over the retainer lip of the cam surfaces and snap into the snap lock flats where the snap locks retain the lock barrel against axial movement.

This arrangement allows the lock with its lock bar to be maneuvered into the lock socket and then simply snapped in place. The snap lock retainers have adequate resilience and strength to hold the lock firmly in snapped position against any axial movement. The assembly needs no fasteners or anchorage other than the escutcheon plate, which is secured to the safe by an interlock with the concrete insulation material that fills the safe.

### DESCRIPTION OF THE DRAWINGS

FIG. 1 provides a perspective view from the outside of a portable fireproof safe including our snap-in lock retention system.

FIG. 2A provides a front view of a lower escutcheon incorporating our snap-in lock retention system.

FIG. 2B provides a back view of a lower escutcheon incorporating our snap-in lock retention system.

FIG. 3A provides a front perspective view of a lower escutcheon incorporating our snap-in lock retention system.

FIG. 3B provides a first back perspective view of a lower escutcheon incorporating our snap-in lock retention system.

FIG. 4A provides a second back perspective view of a lower escutcheon incorporating our snap-in lock retention system.

FIG. 4B provides a more detailed back view of the lock socket of our snap-in lock retention system.

FIG. 5A provides a perspective view of the snap-in lock used in our snap-in lock retention system.

FIG. 5B provides a side view of the snap-in lock used in our snap-in lock retention system.

### DESCRIPTION OF THE INVENTION

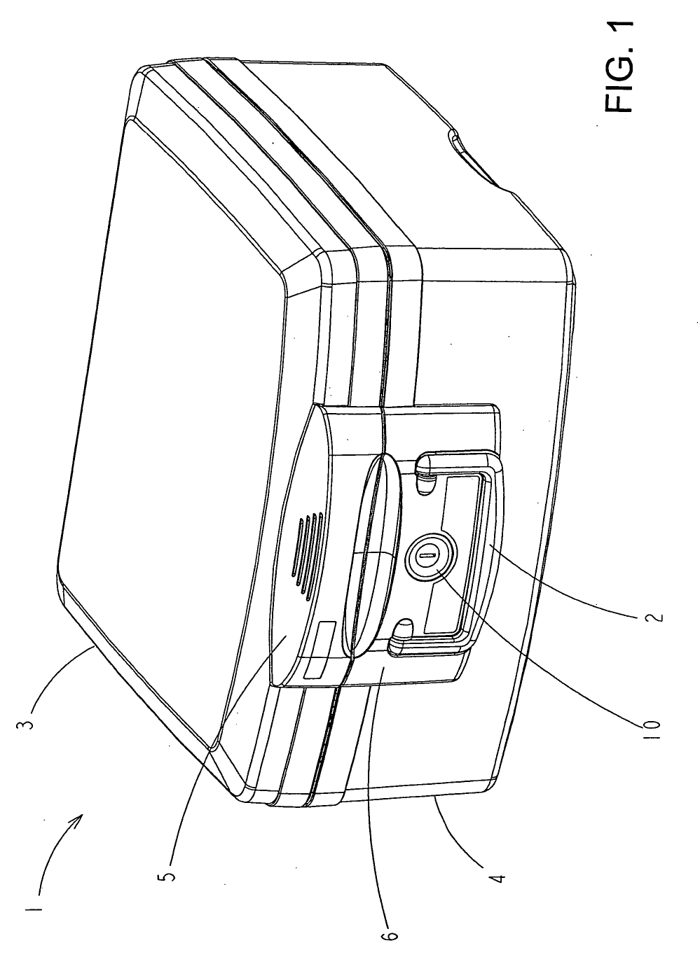

FIG. 1 illustrates a portable fireproof safe (denoted generally by arrow 1) with handle 2, lid 3, and base 4. As previously discussed, lid 3 and base 4 are formed by joining molded interior and exterior shells and filling the space between with a fireproof filler such as concrete. Upper escutcheon plate 5 and lower escutcheon plate 6 are affixed in this concrete before it hardens via upper anchors (not shown) and lower anchors 6A in a manner typical for our safes of this type.

As better seen in the remaining drawing figures, our invention allows a key cylinder lock (denoted generally by arrow 7) to be snap fit into an escutcheon plate (such as lower escutcheon plate 6) in a secure mount that holds the lock 7 irremovably in place in a proper position so that it cannot rotate and cannot slide axially inward or outward. It eliminates the need for any fastener, since the complete locking effect is supplied by the interlocking features of lock 7 and its lock socket (denoted generally by arrow 8) located in lower escutcheon plate 6.

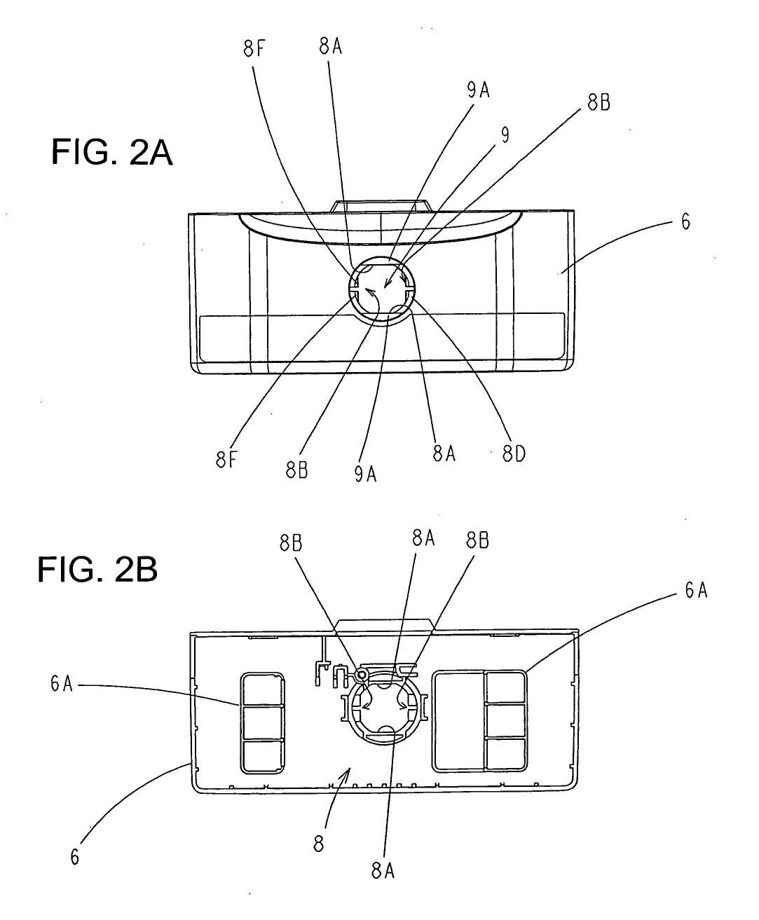

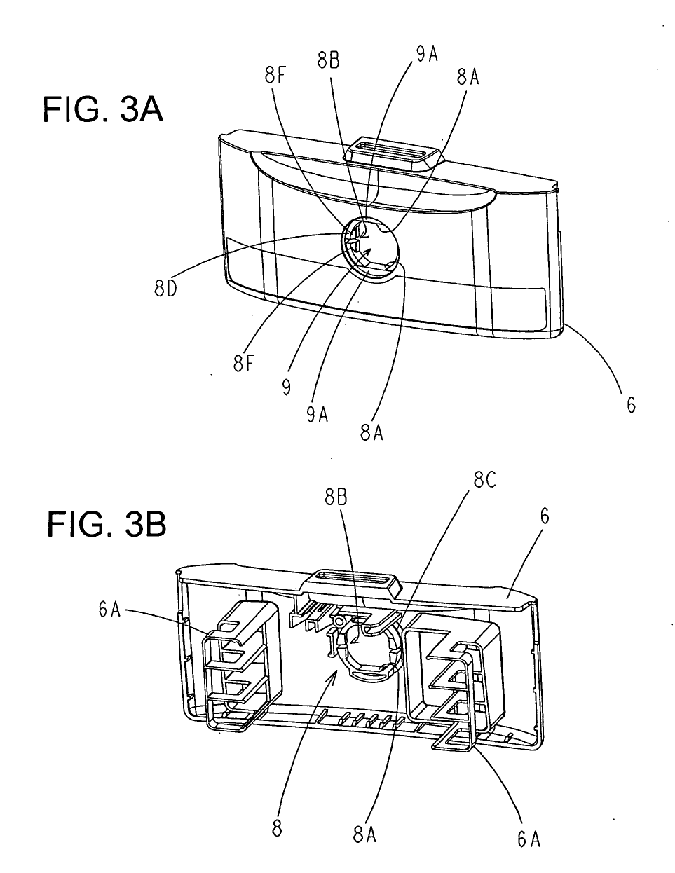

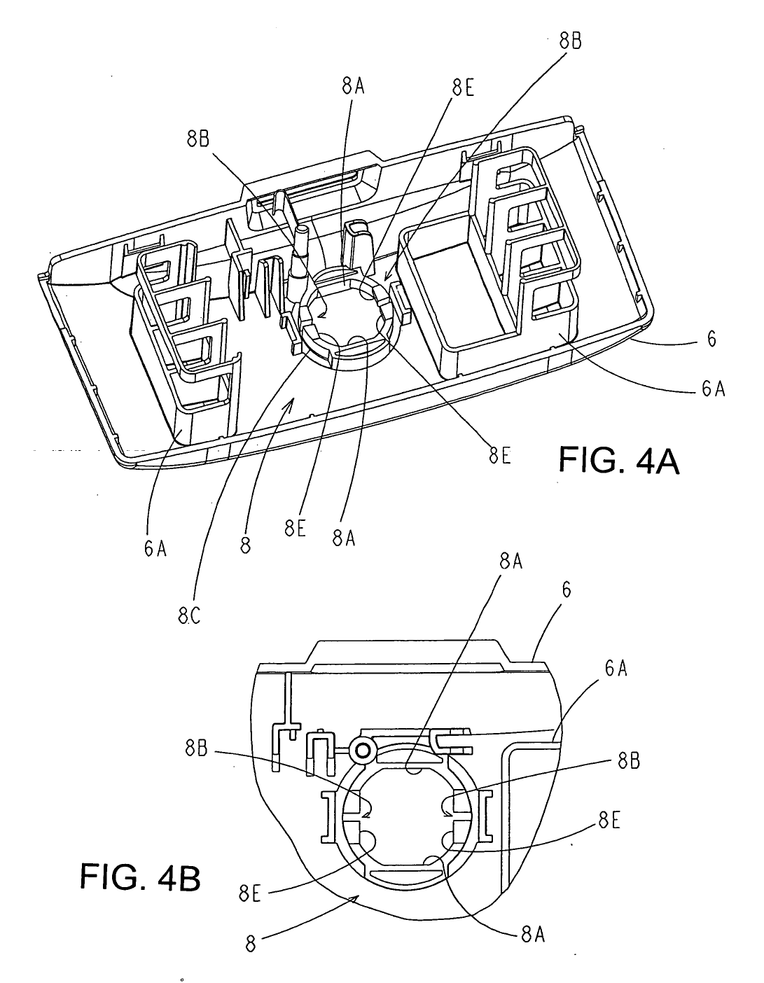

Lock socket 8 with its key cylinder aperture (denoted by arrow 9) is molded into lower escutcheon plate 6. (See, FIGS. 2A through 4B.) It has a pair of lock alignment flats 8A to receive lock 7 in a proper orientation and block rotational movement of lock 7 after it is received. It also has an opposed pair of resilient snap locks (denoted by arrows 8B) that are free to move radially in and out by virtue of slots 8C that partially separate the snap locks 8B from the rest of lower escutcheon plate 6 and lock socket 8. Slots 8C (and the arms of snap locks 8B) are perpendicular to the central axis of cylindrical key cylinder lock 7 and generally parallel to escutcheon plate 6. Thus, snap locks 8B also flex outward and inward in a plane that is perpendicular to the axis of lock 7 and generally parallel to escutcheon plate 6. Snap locks positioned on arms flexing in a plane parallel to lock 7 could also be used. However, our arrangement is more advantageous as it allows for a more compact and unobtrusive lock socket 8. It also makes it easier to insert our preferred lock 7 with lock bar 12 into socket 8.

Lock socket 8 is adapted by shape and design to have the back end 7A of lock 7 inserted therein via aperture 9 until only its front end 7B is accessible via aperture 9. Insertion blocking ledges 9A of aperture 9 extend radially inward so as to come into contact with an insertion blocking member such as flange 10 of lock 7 when lock 7 is fully inserted into aperture 9, thereby blocking further inward movement of lock 7.

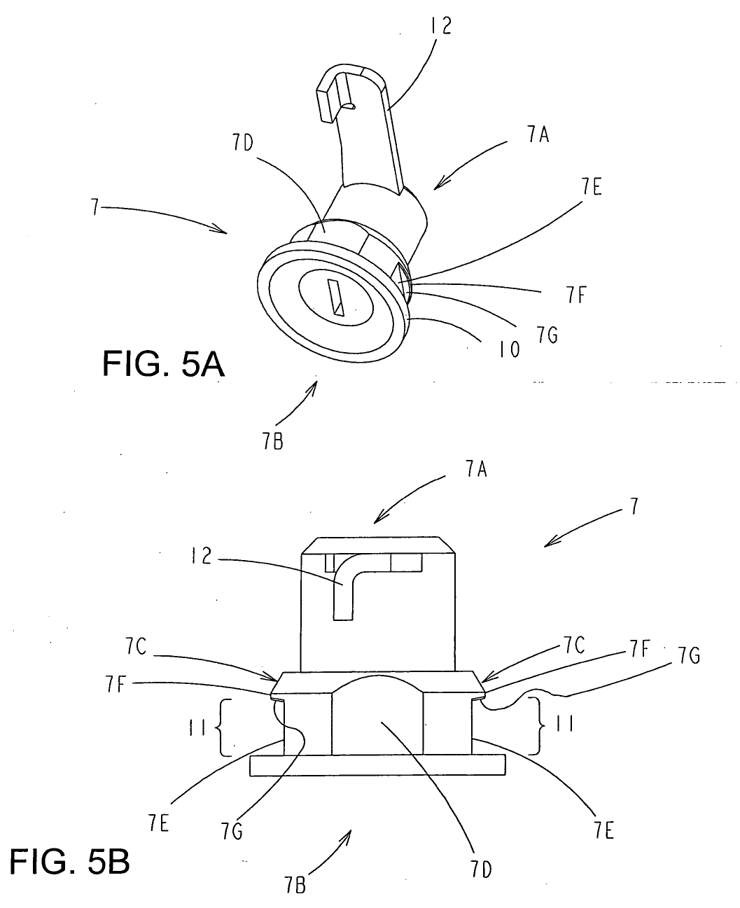

As illustrated in FIGS. 5A and 5B, lock 7 has removal blocking members comprised of opposing cam surfaces 7C leading up the diameter (denoted by bracket 11) that fits into lock socket 8. Diameter 11 includes a pair of socket alignment flats 7D sized and positioned to allow insertion only when aligned with lock alignment flats 8A of lock socket 8. It also includes a pair of snap lock flats 7E behind cam surfaces 7C. As lock 7 is inserted, cam surfaces 7C radially spread open resilient snap locks 8B. Snap locks 8B (assisted in part by ramped edges 8F) pass over retainer lips 7F of cam surfaces 7C and snap into snap lock flats 7E. Removal blocking surfaces 7G retain lock 7 in socket 8 by blocking subsequent outward axial movement and removal. The outward facing surfaces 8D of snap locks 8B, like blocking ledges 9A, serve to block further inward movement by flange 10. (In order to avoid overcrowding of the drawing figures, not all outward facing surfaces 8D are numbered.) Similarly, the snug abutment of flat snap lock aperture edges 8E with snap lock flats 7E serve, along with the snug abutment of socket alignment flats 7D and lock alignment flats 8A, to prevent rotation of lock 7. (In order to avoid overcrowding of the drawing figures, not all of the snap lock aperture edges 8E are numbered.)

Our invention allows lock 7 with its lock bar 12 to be maneuvered into lock socket 8 via aperture 9 and then simply snapped into place. The assembly needs no fasteners or anchorage other than escutcheon plate 6, which is secured to safe 1 by its interlock with the concreter insulation material that fills the walls of safe 1. However, it should be obvious that numerous variations are possible without exceeding the spirit and scope of our invention. The general ambit and scope of which can be better determined by examination of the claims that follows.

1. A lock retainer assembly, comprising a lock cylinder and a socket combination wherein the lock cylinder is retained in the socket by a retainer lip of the lock cylinder that limits extraction after insertion, the retainer lip being positioned at the edge of a cam surface on the lock cylinder and having a snapped interlock with a snap lock having radially flexible arms molded into the socket, wherein a substantial portion of each of the arms lie in a plane that is substantially perpendicular to an axis of the lock cylinder and the arms being forced radially outward by the cam surface as the lock cylinder is inserted.

2. A lock retainer assembly as recited in claim 1, wherein said socket includes at least one lock alignment flat and the lock cylinder includes at least one socket alignment flat for alignment with the at least one lock alignment flat to assure a proper orientation of the lock cylinder in the socket.

3. A lock retainer assembly as recited in claim 2, wherein alignment and abutment of said lock alignment flat and said socket alignment flat prevent rotation of the lock cylinder around its axis.

4. A lock retainer assembly as recited in claim 1, further including an outer rim on the lock cylinder that limits its depth of axial insertion into the socket.

5. A lock retainer assembly as recited in claim 2, further including an outer rim on the lock cylinder that limits its depth of axial insertion into the socket.

6. A lock retainer assembly as recited in claim 1, wherein said lock cylinder further includes a snap lock flat such that abutment of said snap lock flat and said snap lock prevents rotation of the lock cylinder around its axis.

7. A lock retainer assembly as recited in claim 1, further including a cam surface on the snap lock that contacts the cam surface of the lock cylinder when the lock cylinder is being inserted into the socket and facilitates movement of the cam surface of the lock cylinder past the snap lock.

8. A lock retainer assembly, comprising:
a lock cylinder including an outer rim, a cam surface and a retainer lip, the retainer lip being positioned at an edge of the cam surface; and
a socket including a snap lock having radially flexible arms, wherein each of the arms lie in a plane that is substantially perpendicular to a longitudinal axis of the lock cylinder, and wherein the cam surface is used to flex the arms so that the arms are positioned between the retainer lip and the outer rim to retain the lock cylinder in the socket.

9. A lock retainer assembly as recited in claim 8, wherein the socket includes at least one lock alignment flat and the lock cylinder includes at least one socket alignment flat for alignment with the at least one lock alignment flat to assure a proper orientation of the lock cylinder in the socket.

10. A lock retainer assembly as recited in claim 9, wherein alignment and abutment of the lock alignment flat the said socket alignment flat prevent rotation of the lock cylinder around its axis.

11. A lock retainer assembly as recited in claim 8, wherein the lock cylinder further includes a snap lock flat such that abutment of the snap lock flat and the snap lock prevents rotation of the lock cylinder around its axis.

12. A lock retainer assembly as recited in claim 8, further including a cam surface on the snap lock that contacts the cam surface of the lock cylinder when the lock cylinder is being inserted into the socket and facilitates movement of the cam surface of the lock cylinder past the snap lock.
